(19) United States
(12) Patent Application Publication
(10) Pub. No.: US 2002/0040386 A1
(43) Pub. Date: Apr. 4, 2002

(54) Method and device for adapting the content of documents of an information server

(76) Inventors: Bertrand Berthelot, Rennes (FR); Isabelle Amonou, Thorigne-Fouillard (FR); Felix Henry, Rennes (FR)

Correspondence Address: FITZPATRICK CELLA HARPER & SCINTO, 30 ROCKEFELLER PLAZA, NEW YORK, NY, 10112, US

(21) Appl. No.: 09/942,569

(22) Filed: Aug. 31, 2001

(30) Foreign Application Priority Data
Aug. 31, 2000 (FR) 0011133

(51) Int. Cl. G06F 15/16

(52) U.S. Cl. 709/203; 709/217

(57) ABSTRACT

A method of adapting the content of documents on an information server includes the following steps:

receiving (E31) a request by a user for access to one of the documents situated on the information server (1), said access request beginning a communication session; and

analysing (E32) the characteristics contained in said access request.

An adaptation step (E35) adapts the content of at least a second document situated on the information server according to said characteristics, the step (E35) of adapting said second document taking place before the reception of a request for access to said second document.

Use for adapting the documents of a server to a client of a communication network.

The present invention concerns a method of adapting the content of documents on an information server.

It also concerns an adaptation device able to implement the adaptation method according to the invention.

In general terms, the present invention lies within the field of communication networks, of the Internet network type.

In this type of network, numerous electronic documents pass from an information server to a user, also referred to as the client.

The documents delivered by the information servers have varied and generally fairly full contents.

They often include media such as images, sound or video.

However, these electronic documents can be delivered to different terminals, such as office computers, pocket computers, personal digital aids or mobile telephones.

Whilst office computers generally have sufficient power to be able to display or process the electronic documents received, other terminals have relatively limited capacities in terms of memory, screen size, power of the processor, etc.

In this case, the documents received cannot always be displayed or processed.

Various solutions implemented on information servers are known which make it possible to adapt the content itself of the document to the terminal for which it is intended.

In adapting the document account is taken of different characteristics such as physical characteristics of the terminal, characteristics of the network, or certain characteristics peculiar to the user.

The transformations made on the documents of a server are principally intra-media conversions (change in the size or quality of an image for example), and inter-media conversions (conversion of a sound into text for example or video sequences into fixed images).

A first solution consists of dynamically adapting all the documents of a computer server.

In practice, this dynamic adaptation is effected as the client accesses the data.

Thus, when the server receives a request for access to a page of a document, the data contained in this page are transformed before sending this page.

This solution has the drawback of creating additional delays in the sending of a document to the user due to the processing times.

A second solution consists of adapting all or part of the documents present on the server as soon as they are created.

In practice, the information server automatically generates multiple versions of the documents (for example the same image at different resolutions).

This solution enables the information server to have different versions of the same document adapted to different clients.

However, it requires a very large amount of storage space in order to be able to store the different versions of the same document.

In addition, this static adaptation cannot take into account all the different types of existing terminals and the information server must consequently effect a dynamic adaptation of the documents for certain particular users of the network.

The aim of the present invention is to resolve the aforementioned drawbacks and to propose a method of adapting the content of documents making it possible to generate all the versions, and only those, necessary to a given user.

To this end, the present invention relates to a method of adapting the content of documents on an information server, including the following steps:

receiving a request by a user for access to one of the documents situated on the information server, said access request beginning a communication session; and

analysing the characteristics contained in said access request.

In accordance with the invention, this adaptation method comprises a step of adapting the content of at least a second document situated on the information server according to said characteristics, the step of adapting said second document taking place before the reception of a request for access to said second document.

Thus, by virtue of the invention, the adaptation of the documents on a server is effected, according to the characteristics transmitted by the user accessing the server, as from the start of the communication session.

In addition, the adaptation of the documents is commenced even before these documents are requested by the user, this making it possible not to delay the sending of these documents when there is a request for these documents during the session.

Finally, only the versions necessary and adapted to the user are generated on the information server.

According to a preferred characteristic of the invention, the adaptation step is interrupted on reception of a request for access to a document of the information server.

This interruption of the adaptation step enables the information server to process in priority the different access requests received in order to send the document requested by the user.

The adaptation step can thus be performed without interfering with the processing of the other access requests, during the periods of inactivity of the server on the communication network.

In a particularly advantageous fashion, at the adaptation step, the content of all the documents situated on the information server is adapted according to said characteristics.

Should the information server have sufficient memory space, it is particularly advantageous to adapt all the documents present on this server in order to be able to respond to the multiple requests of the user.

Alternatively, at the adaptation step, the content of only some documents situated on the information server is adapted according to said characteristics.

Thus, it becomes possible to reduce the adaptation step compared with the case wherein all the documents are adapted.

According to another preferred characteristic of the invention, the adaptation method also includes a step of determining an order of processing for adapting the documents situated on the information server.

This determination step makes it possible to apply a given strategy for transforming all the media contained in the different documents accessible.

The aim is to transform the documents in a given order which is, if possible, close to that in which the user may request the different documents.

According to another preferred characteristic of the invention, the adaptation method comprises a step of eliminating the adapted documents of the information server at the end of the communication session between said user and the information server.

Once the communication session has ended, the information server can then dispose of all the documents generated for the user and thus release the memory space used; for storing these data.

Correlatively the present invention concerns a device for adapting the content of documents on an information server, comprising:

means of receiving a request by a user for access to one of the documents situated on the information server; and

means of analysing characteristics contained in said access request.

According to the invention, this adaptation device comprises means of adapting the content of at least a second document situated on the information server according to said characteristics, the adaptation of said second document taking place before the reception of a request for access to said second document.

This adaptation device has characteristics and advantages similar to those described previously for the adaptation method which it implements.

The present invention also relates to an information server and a communication network comprising means for implementing the adaptation method according to the invention.

Finally, the present invention relates to a computer program which can be read by a microprocessor comprising portions of software codes or program instructions adapted to implement the adaptation method according to the invention.

Other particularities and advantages of the invention will also emerge from the following description.

In the accompanying drawings, given by way of non-limitative examples:

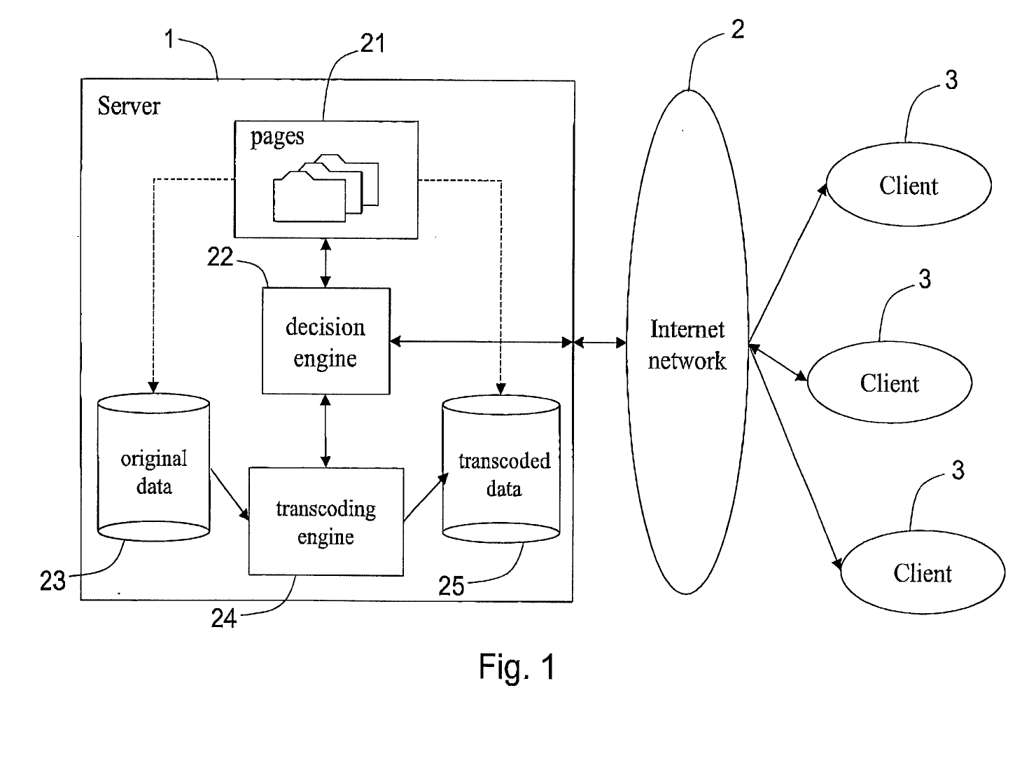

FIG. 1 is a diagram illustrating a communication network adapted to implement the adaptation method according to the invention;

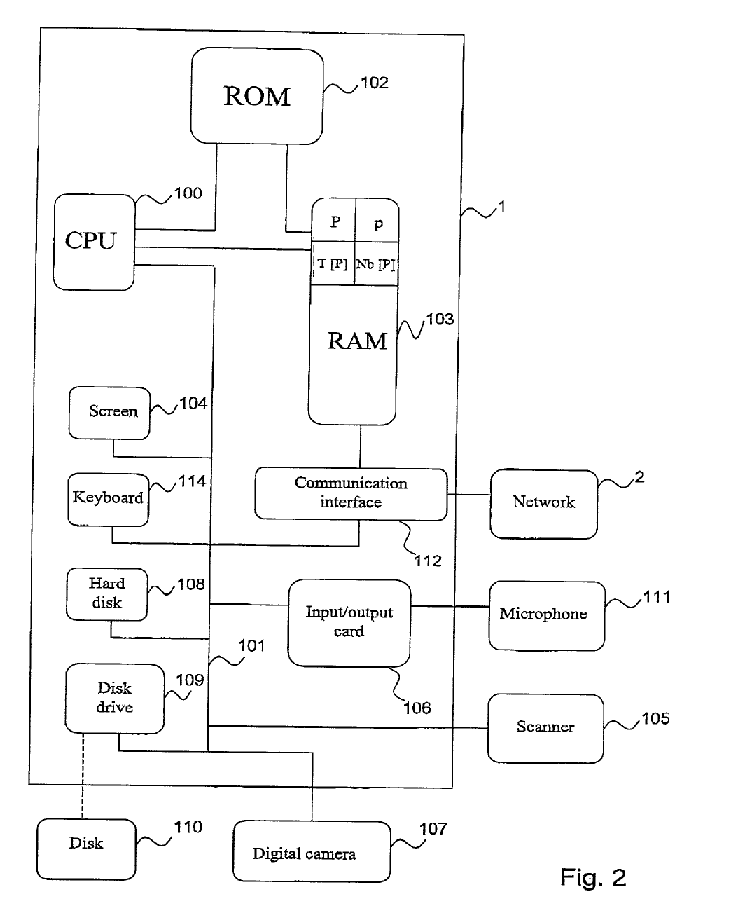

FIG. 2 is a block diagram illustrating a computer adapted to implement the adaptation method according to the invention;

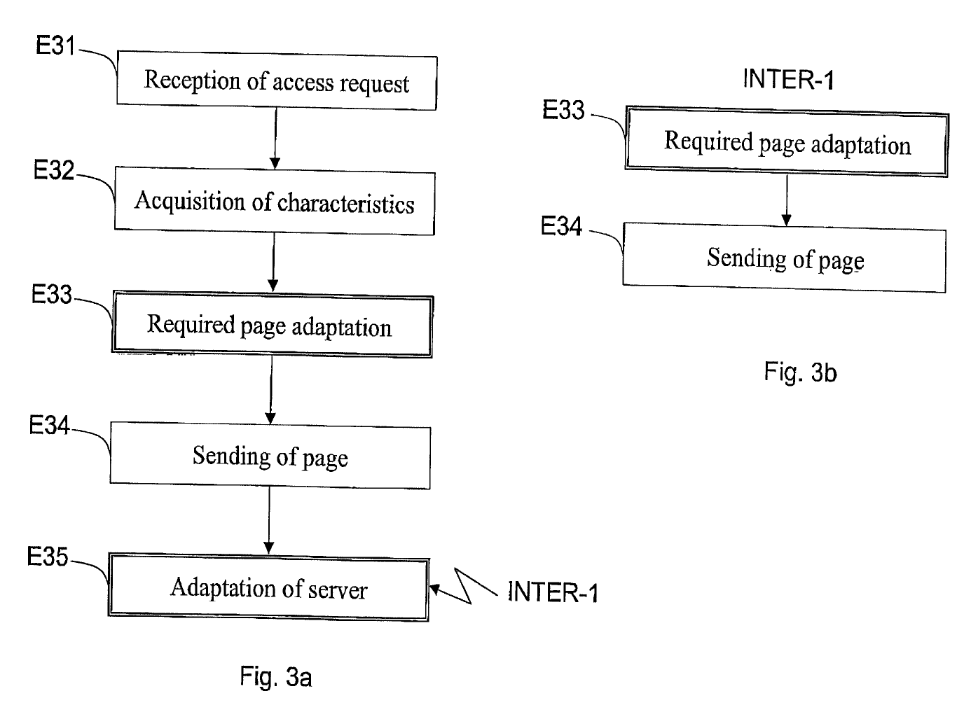

FIGS. 3a and 3b are algorithms illustrating the adaptation method according to an embodiment of the invention;

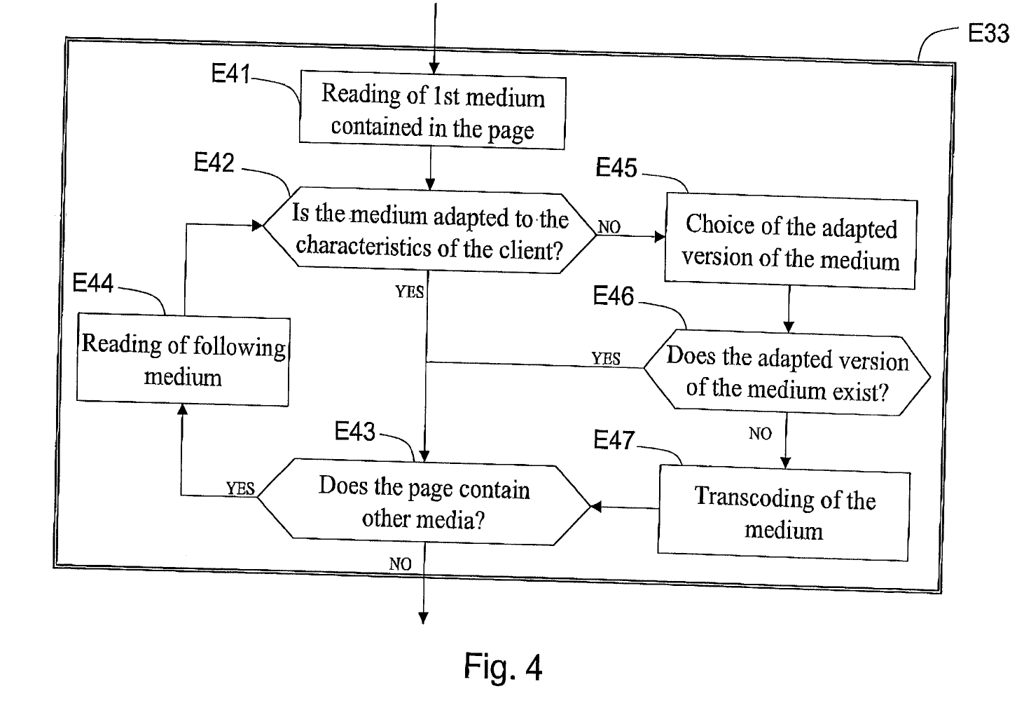

FIG. 4 is an algorithm detailing the step of adapting a page in FIG. 3a;

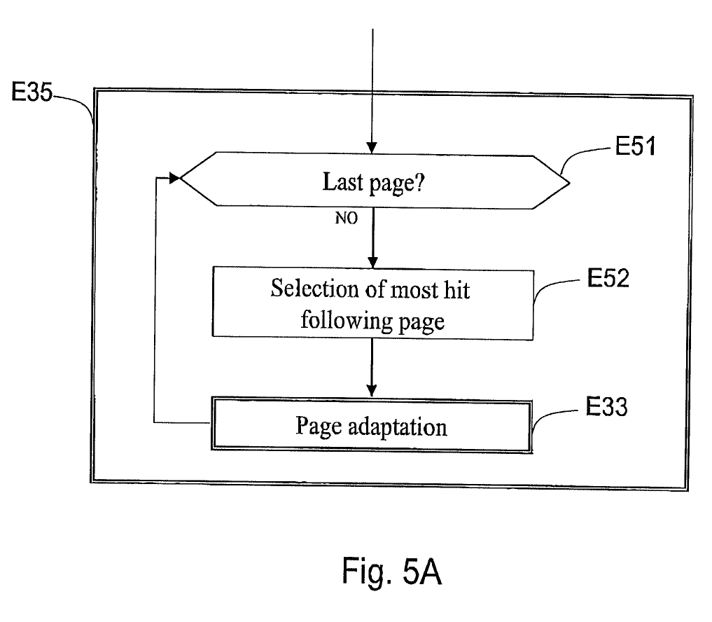

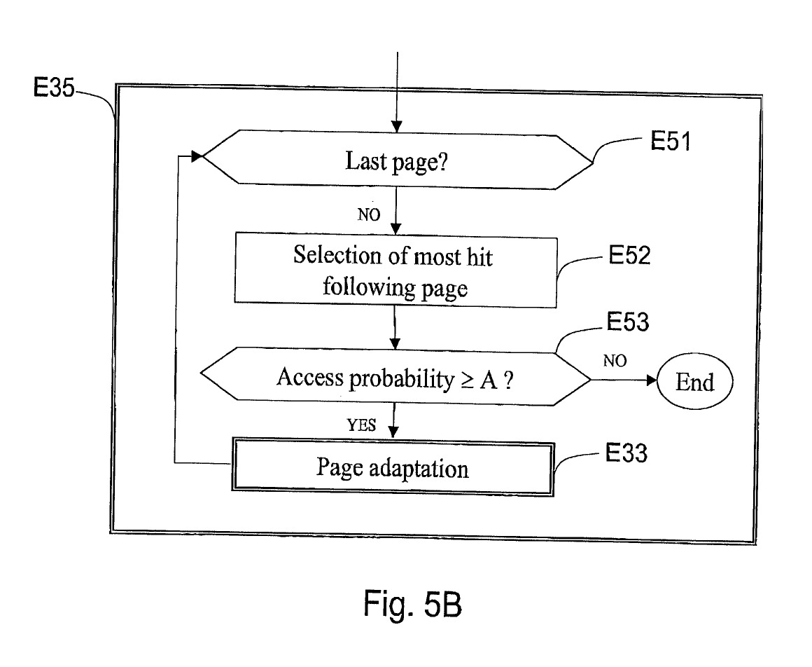

FIGS. 5A and 5B are algorithms illustrating an order of processing for the adaptation of the documents in accordance with a first embodiment of the invention;

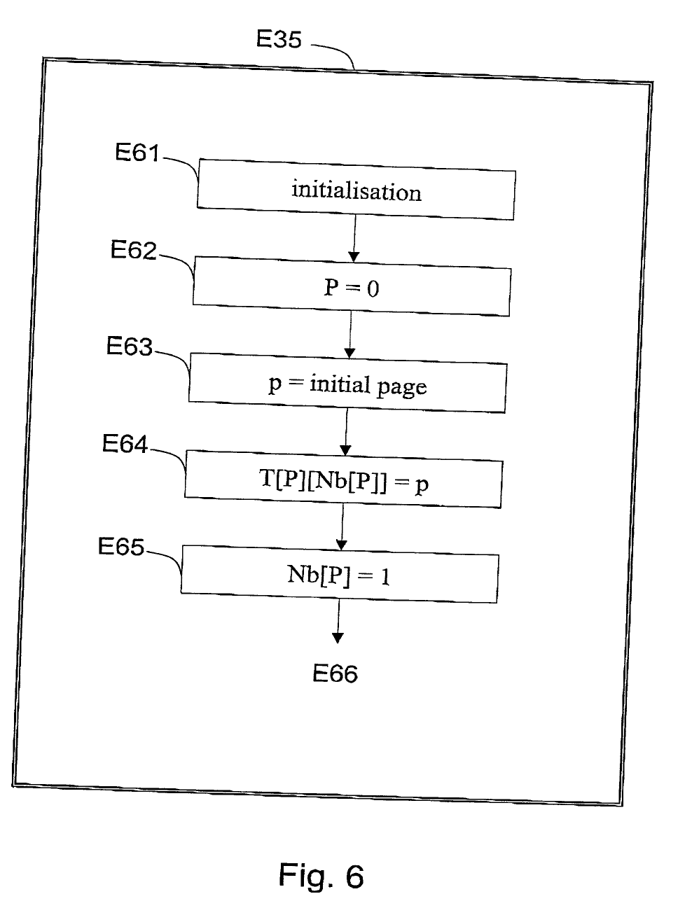

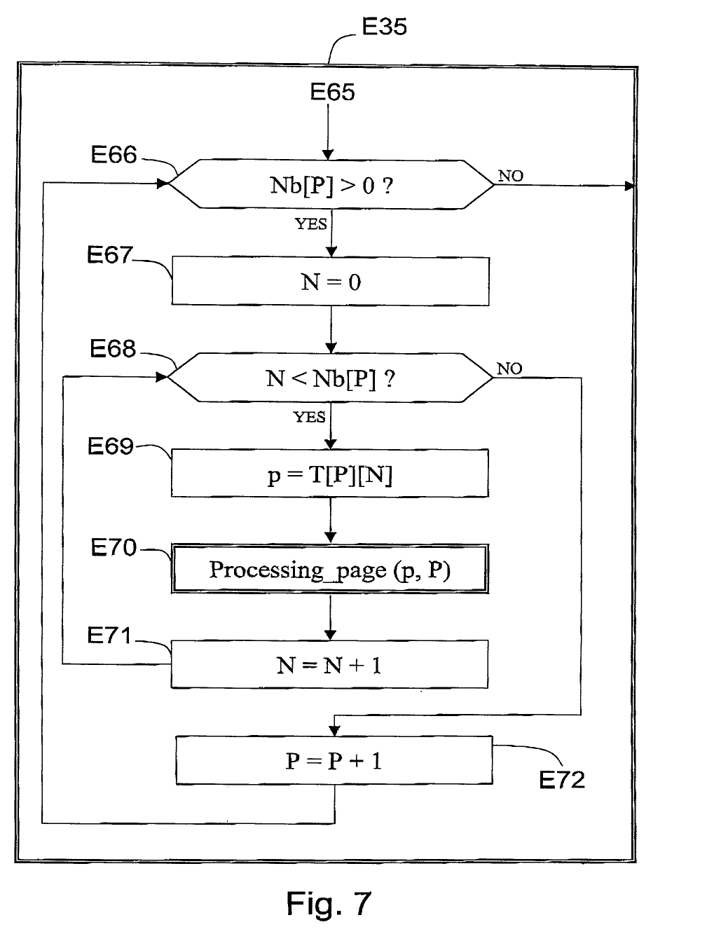

FIGS. 6 and 7 are algorithms illustrating an order of processing for the adaptation of the documents according to a second embodiment of the invention;

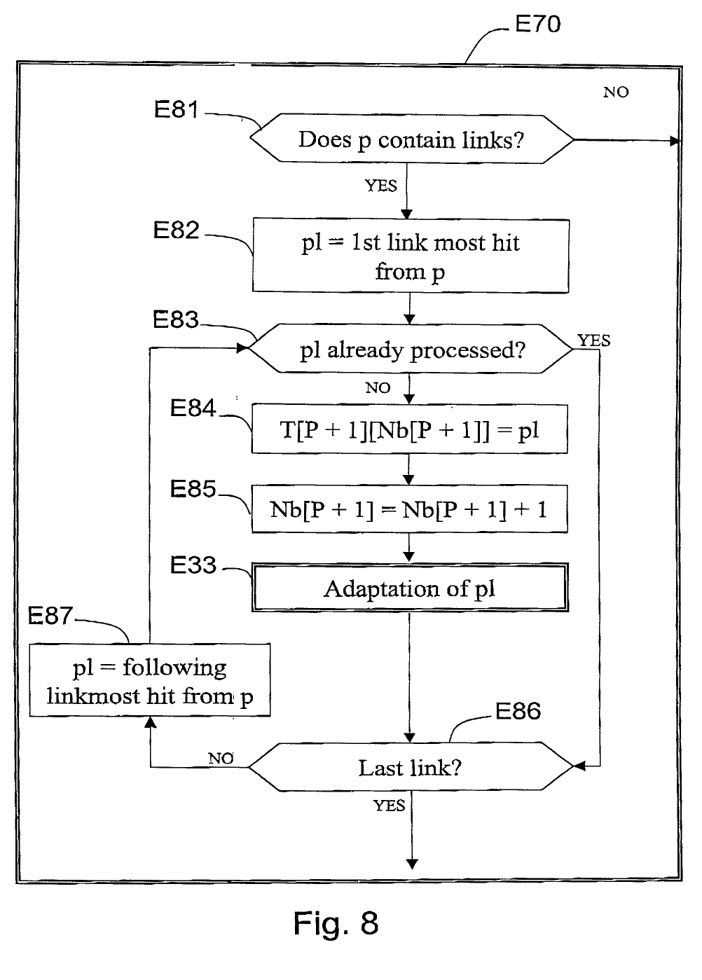

FIG. 8 is an algorithm detailing the step of processing a page of the second embodiment illustrated in FIGS. 6 and 7; and

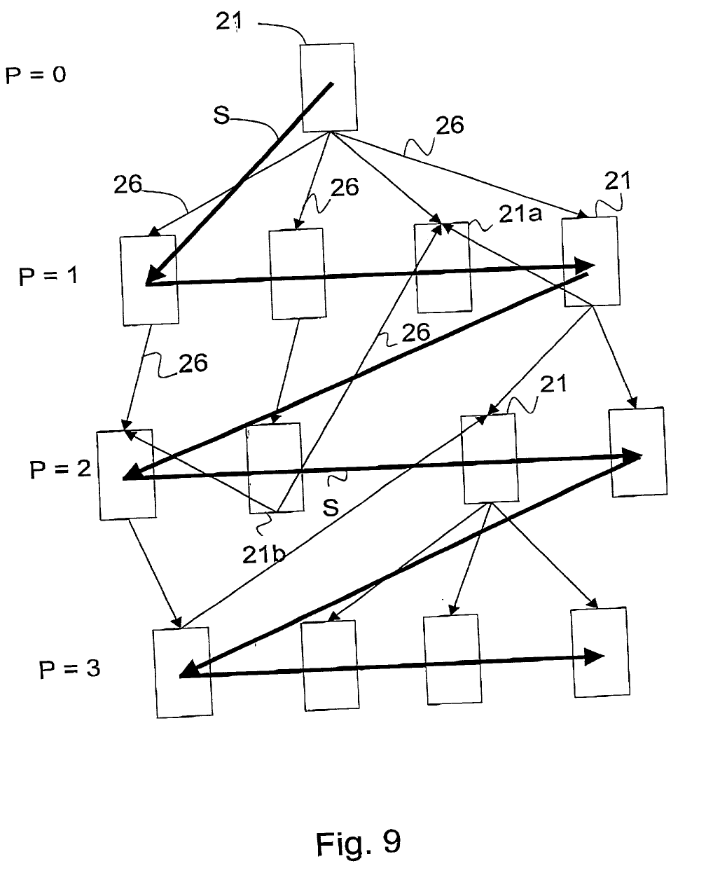

FIG. 9 is a diagram illustrating the order of processing of the documents according to a second embodiment illustrated in FIGS. 6 and 7.

A description will first of all be given, with reference to FIG. 1, of a communication network, of the Internet network type, able to implement the adaptation method according to the invention.

A communication network 2 makes it possible to exchange electronic data between a server 1 and several clients 3 accessing the network.

In this type of client/server architecture such as the Internet network, it is important to be able to adapt the content of multimedia data distributed by the server 1 according to the capacities of the client 3.

In the Internet network, the server 1 comprises documents consisting here non-limitatively of Web pages.

These Web pages 21 are generally written in a data description language such as the HTLM language (Hyper Text Markup Language).

The exchanges or communication of information or data are effected by means of the Internet network 2.

By way of example, all the exchanges between the clients 3 of the Internet network 2 and the information server 1 are effected by means of a transfer protocol known as HTTP (Hyper Text Transfer Protocol).

Naturally, a communication network of the Internet type 2 can include many information servers 1

The Web pages 1 generally contain links to multimedia documents such as images, sound or video.

These original multimedia data are stored for example in a directory 23 to which the links contained in each page 21 point.

This information server 1 also has a decision engine 22 which allows to process the access requests received by means of the communication network 2.

This decision engine 22 thus has at the same time means of receiving requests and means of analysing these requests and notably of analysing the characteristics contained in these requests.

The decision engine 22 also makes it possible to send the responses and documents requested by each client 3 of the communication network 2.

This decision engine 22 also controls a transcoding engine 24 which allows to adapt the content of the documents situated on the server 2 notably according to the characteristics read in an access request.

In practice, this transcoding engine 24 transforms the original data stored in the directory 23 into transcoded data stored in a second directory 25.

The decision engine 22 will in this case modify the links contained in the different Web pages 21 so as to make these links point to the second directory 25 containing the transcoded data.

In accordance with the invention, and as will be clearly described subsequently with reference to the adaptation method, the decision engine 22 controls the transcoding engine 24 so as to transcode the original data of the directory 23 according to characteristics associated with a client 3 who began a communication session with the information server 1.

The order in which the transcoding of the data will be performed is also determined by the decision engine 22 by applying a given strategy.

In addition, the second directory 25 is adapted to store all the data transcoded from the original data of the information server 1.

At the end of each communication session between a client 3 and the information server 1, this second directory 25 is erased so as to eliminate all the transcoded data taking account of the characteristics of the client 3.

In a conventional manner, the entire information server 1 can be incorporated in a computer as illustrated in FIG. 2.

The means described above enabling to implement the adaptation method according to the invention are incorporated in a microprocessor 100 (CPU) communicating by means of a communication bus 101 with a read only memory 102 (ROM) and a random access memory 103 (RAM).

The random access memory 103 can contain registers adapted to store various variables modified during the execution of the adaptation method.

These variables P, p, T [P] and Nb [P] are described below with reference to the adaptation method.

This computer 1 can have a screen 104 enabling to display the data of Web pages of the server 1.

A keyboard 114 or any other means, for example a mouse, can make it possible to parameterise all the data stored on the server.

The computer 1 is connected to different peripherals, for example a digital camera 107 or a scanner 105 which, by means of a graphics card, can supply a digital image to be inserted in a Web page 21 of the information server 1.

Naturally, other peripherals could be used.

Alternatively, the computer 1 can be connected to a microphone 111 which, by means of an input/output card 106, can supply an audio signal to be stored in a Web page 21.

The computer 1 also has a communication interface 112 connected to the communication network 2 so as to be able to receive access requests from any client 3 of the network and, in response, send documents to the different clients 3.

This computer 1 also has a storage means 108 such as for example a hard disk.

It also has a disk drive 109.

The disk read 110 can be a diskette, a CD-ROM or a DVD-ROM.

The disk 110 or the hard disk 108 can contain multimedia data to be incorporated in a Web page 21 of the server.

They can also contain the program implementing the invention which, once read by the microprocessor 100, will be stored in the hard disk 108.

In a variant of the invention, the program enabling the computer to implement the invention can also be stored in read only memory 102.

In a second variant, the program can be received in order to be stored in an identical manner by means of the communication network 2.

The central unit 100 executes the instructions relating to the implementation of the invention, stored in the read only memory 102 or in any other storage element of the computer 1.

On powering up, the adaptation program implementing the invention, stored in a non-volatile memory, for example the read only memory 102, is transferred into the random access memory 103, which will then contain the executable code of the invention.

The communication bus 101 affords communication between the different elements included in the computer 1 or connected to it.

Naturally, the representation of the bus 101 is not limitative and notably the central unit 100 is able to communicate information to any element of the computer 1 directly or by means of another element of the computer.

In general terms, an information storage means, such as a diskette, which can be read by a computer or by a microprocessor, integrated or not into this computer, and possibly removable, is adapted to store a program implementing the adaptation method according to the invention.

A description will now be given, with reference notably to FIG. 3a, of the method of adapting the content of the documents on the information server 1 implemented according to the invention.

This adaptation method includes first of all a reception step E31 in which the information server 1 receives an access request issued by a user 3 who wishes to access aidocument of the server.

Generally, the client 3 issues a request for accessing the home page or another page amongst those available on the information server 1.

When the user 3 connects for the first time after a certain lapse of time, a new communication session with the information server 1 is initiated.

A communication session corresponds to a space of time during which the user 3 and the server 1 can communicate and exchange data stored both at the server 1 and at the user 3.

During the same communication session, the information server 1 can for example store certain preferences of the user which are not automatically included in all the requests issued by the user 3.

After reception of this first access request, a step E32 of acquiring and analysing the characteristics contained in the access request is implemented.

This acquisition step E32 makes it possible to acquire the characteristics associated with the user 3, which will then be valid throughout the communication session begun.

In the HTIP communication protocol, these characteristics can be incorporated in the header of the HTTP request.

The characteristics analysed at this acquisition step E32 are chosen from amongst:

the characteristics related to the terminal used by the user 3.

These characteristics are physical characteristics of the terminal, such as the size of its screen, the type of display (colour or monochrome), the memory of the terminal, or the capacity of the associated modem.

In addition, these characteristics can take into account the software capabilities of the terminal, such as the presence or not of a browser, an image display, an audio file or video sequence reader.

the characteristics of the communication network 2, and notably the available bandwidth;

characteristics peculiar to the user indicating for example his preferences in terms of waiting time, quality of content of the document requested, etc.

After acquisition and analysis of these characteristics, the latter are stored at the information server 1 so as to be able to be used throughout the communication session.

An adaptation step E33 adapts the content of the page required in the access request according to these characteristics.

This page adaptation step E33 will be described subsequently with reference to FIG. 4.

Once the required page has been adapted, this page is sent to the user 3 in a sending step E34.

Then, in accordance With the invention, an adaptation step E35 is implemented at the server 1 so as to adapt at least a second document situated on this server before even receiving a request for access to this second document.

During this adaptation step E35, the content of all or only some documents situated on the information server 1 is adapted according to characteristics acquired at the acquisition step E32.

This adaptation step E35 will be described subsequently in detail with reference to FIG 5A et seq.

In general terms, however, as soon as the server receives a new request from the user 3, an interrupt Inter-1 is implemented in order to interrupt the adaptation step E35 and to process the new access request received in priority.

As illustrated in FIG. 3b, at the time of this interrupt Inter-1, the steps of page adaptation E33 and page sending E34 are reiterated on the required page in the new access request received.

Naturally, and in accordance with the invention, if this new required page has already been adapted during the server adaptation step E35, the page adaptation step E33 is unnecessary. This page can then be sent without delay at the sending step E34.

This arrangement makes it possible to process in priority the requests received by the information server compared with the adaptation process implemented.

The page adaptation step E33 will now be described in detail with reference to FIG. 4.

In practice, the processed Web page 21 is read and all the media included in this page are processed one after the other.

A reading step E41 reads the first medium included in the required page.

A test step E42 enables the decision engine 22 to verify whether or not this medium read is adapted to the characteristics of the user 3.

In the affirmative, a step E43 makes it possible to check whether the page contains other media, and in the affirmative, to read, in a reading step E44, the following medium of the required page.

If at the end of the test step E42 the medium read is not adapted to the characteristics of the client, a choosing step E45 makes it possible to determine the version of the medium adapted to the characteristics of the client.

In a test step E46 it is checked whether this modified version of the medium exists, that is to, say whether it is already stored in the second directory 25 of the transcoded data.

If not, a transcoding step E47 transcodes this medium read and stores it in the second directory 25.

Then the other media contained in the page are processed by reiterating steps E42 to E47.

A description will now be given with reference to FIG. 5A of a first embodiment of the adaptation step E35 of the adaptation method described in FIG. 3a.

In this embodiment, as soon as an access request starting a communication session is received, all the documents situated on the information server 1 are adapted according to the characteristics of the user 3, without awaiting the reception of subsequent steps sent by the user 3.

It is important, in order to effect this adaptation of the content of the documents, to use a strategy determining an order of processing of the documents.

In this embodiment the order of processing is determined according to the frequency of access to these documents on the information server 1.

It is thus possible to determine an order of priority in which the pages of the information server 1 are run through in order to be adapted.

In practice, once the first page required has been adapted during the page adaptation step E33, it is checked, in a test step E51, whether this required page is the last page of the information server.

In the negative, the following most hit page is selected in a selection step E52.

The access probability can be calculated by the information server 1 using for example the number of times each page of the server has been requested previously by all the users who have been connected to the information server 1.

On this selected page, the page adaptation step E33 as described previously with reference to FIG. 4 is implemented so as to adapt all the media contained in this page.

Then all of steps E51, E52 and E33 described previously are reiterated on the different pages of the information server.

In an other embodiment described in FIG. 5B, only some documents situated on the information server 1 are adapted according to the characteristics of the user 3.

As previously, the order of processing is determined according to the frequency of access to these documents on the information server 1.

In practice, after the selection step E52, wherein the following most hit page is selected, a test E53 is performed in order to compare the access probability to said page with a threshold A.

If the access probability is greater than this threshold A, said page is adapted in the page adaptation step E33 as described previously with reference to FIG. 4.

If not, the adaptation step E35 is ended.

Thus, only the documents having more than a certain number of accesses A are converted in this embodiment.

A description will now be given, with reference to FIGS. 6 to 9, of a second embodiment of the invention in which the order of processing of the documents to be adapted is determined according to the tree of the documents on the information server 1.

In this embodiment, firstly, the pages directly accessible from the first page required will be processed.

This is because, in the HTML description language, the Web pages generally contain one or more links enabling to point to other Web pages.

As illustrated in FIG. 9, the Web pages 21 of an information server 1 contain different links 26 enabling to make other Web pages 21 accessible from a Web page 21.

The different Web pages 21 of the information server 1 can thus be represented in the form of a tree structure as illustrated in FIG. 9.

As illustrated in this FIG. 9, a direction of travel S is defined so as to process the different pages 21 according to the tree of these pages on the information server 1.

In order to determine this order of travel S, in practice use is made of a table T with two dimensions pointing to Web pages. The first dimension is indexed by a depth index P.

This depth P can be interpreted as being the number of links to be run through to pass from an initial page to the current page being processed.

The second dimension is indexed by the number of pages existing in the table T [P] for a given depth P.

Use is also made of another table with one dimension also indexed by the depth P.

This table Nb [P] contains the number of pages for each different depth.

An additional variable p defines a pointer to a page of the information server 1.

All these variables and tables can be stored in the registers of the random access memory 103 illustrated in FIG. 2.

As illustrated in FIG. 6, an initialisation step E61 initialises the tables for each depth P.

In practice, the table T [P] is empty and the table Nb [P]=0.

Next a depth P=0 is considered in a reading step E62 and the pointer p is initialised, considering the initial page required by the user in an initialisation step E63.

The table T [P] [Nb[P]] then points to this page p, in a step E64, and, in an incrementation step E65, the page number Nb [P] is incremented by 1 for this depth P=0.

As illustrated in FIG. 7, it is next checked, in a test step E66, whether this depth P does not contain any page.

In practice the table Nb [P] is compared with 0 and, if this number Nb [P] is strictly positive, an index N is initialised to 0 in an initialisation step E67. It is next checked, in a test step E68, whether the number Nb [P] is strictly greater than the index N. In the affirmative, in an association step E69, the value of the table T [P] [N] is associated with the pointer p, and then this page is processed in a processing step E70.

This processing step E70 will be described with reference to FIG. 8.

Next, in an incrementation step E71, the index N=N+1 is incremented and all of steps E68 to E71 are reiterated so as to process all the pages at a given depth P.

When all the pages have been processed, that is to say at the end of the test step E68, the number of pages at this depth P is less than or equal to the index N, the following depth is considered in an incrementation step E72 in which P=P+1.

Next, for this new depth P, all of steps E66 to E71 are reiterated in order to process all the pages at this depth P.

Thus the direction of travel S is obtained as illustrated in FIG. 9, making it possible to process all the pages 21 of the server in increasing order of depth P.

A description will now be given, with reference to FIG. 8, of the processing of the pointed-to page p at the processing step E70.

It is first of all checked, in a test step E81, whether this page p does not contain any link. Such is the case, for example, with the Web pages 21a illustrated in the tree structure in FIG. 9.

In this case, the processing process E70 is terminated and the following page is considered at the same depth P, if such exists, in the incrementation step E71 described previously.

Next each pate pl connected to the current page p is processed in an order of priority based on the probability that each page has of being requested by the user.

As in the first embodiment described with reference to FIG. 5, this order of priority can be determined from statistics established on the frequencies of access to each page of the information server 1.

Thus, in a reading step E82, there is considered the page pl corresponding to the link most hit from the current page p.

In a test step E83 it is checked whether this page pi has not already been processed.

As illustrated by way of example in FIG. 9, when the page 21b is processed, the latter points to the page 21a which has already been processed during the processing of the pages at a lower depth.

If such is the case, it is checked, at the reading step E86, whether there is another link from the current page p, and at step E87 the following page p1 corresponding to the following link, the most hit from the current page p, is considered.

Next the test step E83 et seq is reiterated on this new page pl.

At the pointing step E84, if the page pl has not been processed, the table T [P+1] [Nb [P+1]] is made to point to this page pl, and, at the incrementation step E85, the number of pages Nb [P+1]=Nb [P+1]+1 is incremented in the table T for the depth P under consideration.

Then, on the page pl, the page adaptation step E33 proper is implemented, described previously with reference to FIG. 4.

Thus all the links of the current page p are processed in succession.

The adaptation of the pages 21 of the information server 1 is thus performed following the tree of the documents stored on this server 1.

The present invention consequently makes it possible to adapt the documents of an information server to the characteristics related to a client 3, during the communication session.

In order not to clutter the memory of the server, the adapted versions of the documents are eliminated at the end of each communication session with a client.

Naturally, several adaptation processes according to the invention could be implemented in parallel on the same information server, when several users 3 are connected to the information server 1 at the same time.

1. Method of adapting the content of documents (21) on an information server (1), including the following steps:
receiving (E31) a request by a user (3) for access to one of the documents (21) situated on the information server (1), said access request beginning a communication session; and
analysing (E32) the characteristics contained in said access request;
characterised in that it comprises a step of adapting (E35) the content of at least a second document situated on the information server (1) according to said characteristics, the step of adapting (E35) said second document taking place before the reception of a request for access to said second document.

2. Adaptation method according to claim 1, characterised in that the adaptation step (E35) is interrupted on reception of a request for access to a document on the information server (1).

3. Adaptation method according to one of claims 1 or 2, characterised in that, at the adaptation step (E35), the content of all the documents situated on the information server (1) is adapted according to said characteristics.

4. Adaptation method according to one of claims 1 or 2, characterised in that, at the adaptation step (E35), the content of only some documents situated on the information server (1) is adapted according to said characteristics.

5. Adaptation method according to one of claims 1 to 4, characterised in that it also includes a step (E35) of determining an order of processing for the adaptation of the documents situated on the information server (1).

6. Adaptation method according to claim 5, characterised in that, at the determination step (E35), the order of processing of the documents is determined according to the frequency of access to these documents on the information server (1).

7. Adaptation method according to claim 6, characterised in that only some documents having a frequency of access greater than a threshold are adapted.

8. Adaptation method according to claim 5, characterised in that, at the determination step (E35), the order of processing of the documents is determined according to the tree of the documents on the information server (1).

9. Adaptation method according to one of claims 1 to 8, characterised in that, at the analysis step (E32), the characteristics contained in said access request are chosen amongst characteristics of a terminal of said user (3), characteristics of a communication network (2) between said user (3) and the information server (1), and characteristics peculiar to the user (3).

10. Adaptation method according to one of claims 1 to 9, characterised in that it also comprises a step of eliminating said adapted documents on the information server (1) at the end of the communication session between said user (3) and the information server (1).

11. Device for adapting the content of documents (21) on an information server (1), comprising:
means (22) of receiving a request by a user (3) for access to one of the documents (21) situated on the information server (1); and
means (22) of analysing characteristics contained in said access request;
characterised in that it comprises means (22) of adapting the content of at least a second document situated on the information server (1) according to said characteristics, the adaptation of said second document taking place before the reception of a request for access to said second document.

12. Adaptation device according to claim 11, characterised in that it also has means (22) of determining the order of processing for the adaptation of the documents (21) situated on the information server.

13. Adaptation device according to one of claims 11 or 12, characterised in that it also comprises means (22) of eliminating adapted documents of the information server at the end of said communication session between the user (3) and the information server (1).

14. Adaptation device according to one of claims 11 to 13, characterised in that said means of receiving (22), analysing (22), adapting (24) and possibly determining (22) and eliminating (22) are incorporated in:
a microprocessor (100),
a read only memory (102) adapted to store a program for adapting the content of documents; and
a random access memory (103) comprising registers adapted to store variables modified,,during the running of said program.

15. Information server, characterised in that it comprises means adapted to implement the adaptation method according to one of claims 1 to 10.

16. Communication network comprising at least one information server (1) delivering documents (21) to one or more users (3) of the information network (2), characterised in that it comprises means adapted to implement the adaptation method according to one of claims 1 to 10.

17. Computer program, readable by a microprocessor comprising portions of software codes adapted to implement the adaptation method according to one of claims 1 to 10.
